(19) United States
(12) Patent Application Publication
(10) Pub. No.: US 2009/0251608 A1
(43) Pub. Date: Oct. 8, 2009

(54) Image Processing Apparatus and Image Processing System

(75) Inventor: Akiyoshi Kato, Kawasaki-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/484,890

(22) Filed: Jun. 15, 2009

Related U.S. Application Data
(63) Continuation of application No. PCT/JP2008/064070, filed on Jul. 30, 2008.

(30) Foreign Application Priority Data
Aug. 8, 2007 (JP) 2007-206955

(51) Int. Cl. H04N 5/445

(52) U.S. Cl. 348/564; 348/E05.099

(57) ABSTRACT

According to one embodiment, a communication unit communicates a control signal to/from another image processing apparatus via a communication channel and receives video/audio signals from the another image processing apparatus via the communication channel. A processing prediction unit transmits, to the another image processing apparatus, a request signal to request a transmission of a schedule of processing for a predetermined command. The processing prediction unit receives a message signal indicating the processing schedule corresponding to the predetermined command from the another image processing apparatus. The processing prediction unit generates an image showing the processing schedule corresponding to a predetermined command indicated by message signal when requested to execute the predetermined command. A display unit displays, on a screen, an image corresponding to the video/audio signals and an image showing the processing schedule corresponding to the predetermined command.

### CROSS REFERENCE TO RELATED APPLICATIONS

This is a Continuation Application of PCT Application No. PCT/JP2008/064070, filed Jul. 30, 2008, which was published under PCT Article 21(2) in English. This application is based upon and claims the benefit of priority from Japanese Patent Application No. 2007-206955, filed Aug. 8, 2007, the entire contents of which are incorporated herein by reference.

### BACKGROUND

1. Field

One embodiment of the present invention relates to an image processing apparatus and an image processing system, the image processing apparatus having a communication function based on, for example, a high-definition multimedia interface (HDMI) standard and dealing with processing schedule information for a particular command.

2. Description of the Related Art

A high-definition multimedia interface (HDMI) standard is known and used as a communication standard for communications among a plurality of image processing apparatuses at different velocities for video/audio signals and a control signal. When an image processing system using such a communication standard is constructed, it is possible to perform, for example from a sink device (image display device) having a display function, the operation of turning on and off a source device (image output device) which supplies a source.

Generally, in an image processing system, a hard disk recorder, for example, performs processing such as continuation of recording without turning off the power during recording when receiving a command to turn off the power. Thus, the source device does not always operate as commanded by the sink device. As a result, a user may misunderstand that, for example, the system has failed.

Jpn. Pat. Appln. KOKAI Publication No. 2001-195807 has disclosed a technique which queries a user whether to stop recording of program image data on a recording medium in the case where it is detected that a reproduction image catches up with a broadcast program when the broadcast program being recorded is reproduced.

However, in the conventional technique in Jpn. Pat. Appln. KOKAI Publication No. 2001-195807, when an instruction is received from the user, it is not possible for the user to know what kind of processing options a source device has for the instruction. For example, in an image processing system connected in accordance with the HDMI standard, there is no method for a sink device to query the source device.

Furthermore, in a general image processing system, even if a command to turn off a source device is transmitted from a sink device, the source device does not stop reproduction when it is reproducing, for example, video/audio signals, and there is thus a possibility that an operation of a user appears to have been ignored and the user misunderstands that the system has failed.

### BRIEF DESCRIPTION OF THE SEVERAL VIEWS OF THE DRAWINGS

FIG. 1 is a block diagram showing one example of an image processing system including a sink device and source devices connected thereto according to one embodiment of the present invention;

FIG. 2 is a block diagram showing a configuration example of the source device according to one embodiment of the present invention;

FIG. 3 is a block diagram showing a configuration example of the sink device according to one embodiment of the present invention;

FIG. 4 is a diagram showing signal names of an HDMI terminal provided in an image processing apparatus (the source device and the sink device) according to one embodiment of the present invention;

FIG. 5 is an operation flowchart showing one example of a device control operation to which the present invention is not applied in the case of turning off the system;

FIG. 6 is a flowchart showing one example of a processing prediction method for a sink device and source devices according to a first embodiment of the present invention;

FIG. 7 is a flowchart showing one example of a processing prediction method for a sink device and a source device according to a second embodiment of the present invention;

FIG. 8 is a flowchart showing one example of a processing prediction method using an hdml message for a sink device and a source device according to a third embodiment of the present invention;

FIG. 9 shows one embodiment of a command to query about a processing schedule for a power off message;

FIG. 10 shows one embodiment of a command to respond to the query command by “power off (standby) at once”;

FIG. 11 shows one embodiment of a command to respond to the query command by “power off (standby) after recording ends”;

FIG. 12 shows one embodiment of a command to respond to the query command by “continue power on”;

FIG. 13 shows one embodiment of a command to respond to the query command to indicate that “message image exists”;

FIG. 14 shows one embodiment of a command to request to send a message;

FIG. 15 shows one embodiment of a command to query about the update situation of a processing schedule corresponding to an arbitrary message;

FIG. 16 shows one embodiment of a command to indicate that there is no update processing of the processing schedule corresponding to an arbitrary message;

FIG. 17 shows one embodiment of a command to indicate that there is, in an html format, update processing of the processing schedule corresponding to an arbitrary message;

FIG. 18 shows one embodiment of a command to indicate that there is, in an XML format, update processing of the processing schedule corresponding to an arbitrary message;

FIG. 19 shows one embodiment of a command to request to send the processing schedule in the html format;

FIG. 20 shows one embodiment of a command to request to send the processing schedule in the XML format;

FIG. 21 shows one embodiment of response messages and operation messages;

FIG. 22 shows a modification of the response messages and the operation messages; and

FIG. 23 shows one embodiment of a command to report the completion of the reception of the processing schedule.

### DETAILED DESCRIPTION

Embodiments of this invention will hereinafter be described in detail with reference to the drawings.

<Configuration of Image Processing System According to One Embodiment of the Present Invention>

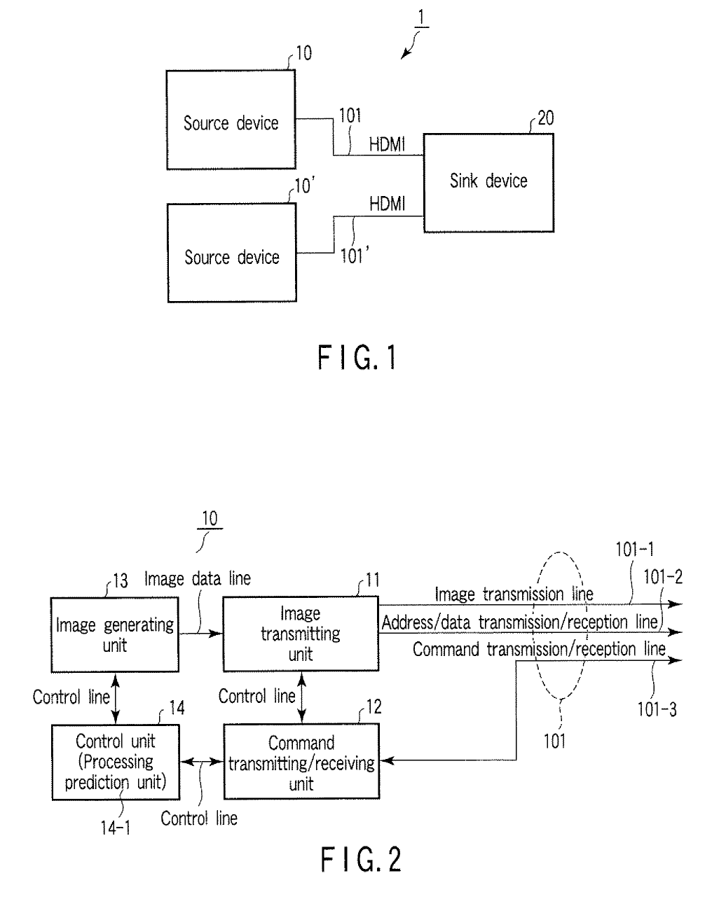

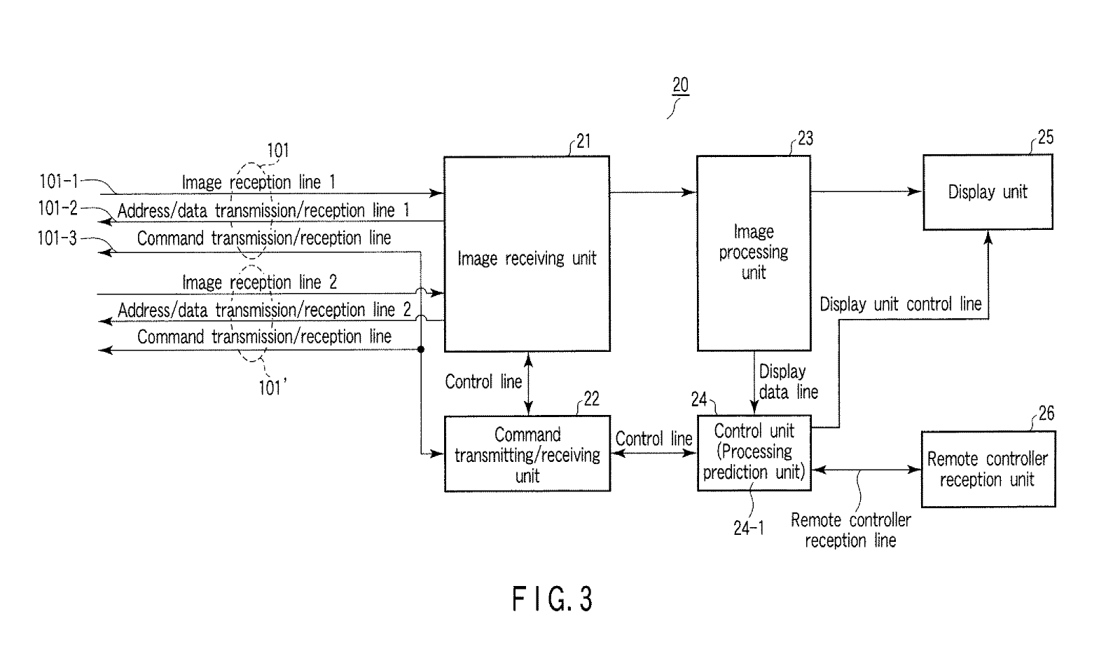

An example of the configuration of an image processing system according to one embodiment of the present invention is described with the drawings. FIG. 1 is a block diagram showing one example of the image processing system according to one embodiment of the present invention, and this system includes a sink device and source devices connected thereto. Both the source devices and the sink device are image processing apparatuses. FIG. 2 is a block diagram showing one example of the configuration of the source device according to one embodiment of the present invention. FIG. 3 is a block diagram showing one example of the configuration of the sink device according to one embodiment of the present invention.

As shown in FIG. 1, an image processing system 1 according to one embodiment of the present invention has a sink device 20 (image display device) connected to a plurality of source devices 10, 10′ (image information output devices) by HDMI cables 101. The source device 10 and the source device 10′ have similar configurations as the image information output devices. As shown in FIG. 2, the HDMI cable 101 includes a transmission line 101-1 for video/audio signals, a transmission/reception line 101-2 for addresses/data, and a transmission/reception line 101-3 for commands. By way of example, the transmission line 101-1 for video/audio signals and the transmission/reception line 101-2 for addresses/data perform faster data communications than the transmission/reception line 101-3 for commands.

As shown in FIG. 3, the sink device 20 is a device for reproducing and displaying the video/audio signals from the source device 10, and is specifically a television or the like. Both the source devices 10, 10′ are devices for transmitting the video/audio signals to the sink device 20, and are specifically HD DVD recorders or the like.

As shown in FIG. 2, the source device 10 has an image generating unit 13 and a control unit 14 which is a central processing unit, and the control unit 14 includes a processing prediction unit 14-1 described later and controls the overall operation. The source device 10 further has an image transmitting unit 11, and the image transmitting unit 11 transmits the video/audio signals to the sink device 20 and transmits/receives addresses/data. Moreover, a command transmitting/receiving unit 12 is a part for transmitting a command (control signal) to control the sink device 20 and for receiving a command (control signal) from the side of the sink device 20.

A message screen for controlling the source device 10 is also sent to the sink device 20 via the command transmitting/receiving unit in a format such as HTML or XML.

As shown in FIG. 3, the sink device 20 has an image processing unit 23 and a control unit 24 which is a central processing unit, and the control unit 24 includes a processing prediction unit 24-1 described later and controls the overall operation. The sink device 20 further has an image receiving unit 21, and the image receiving unit 21 receives the video/audio signals from the source device 10 and transmits/receives addresses/data. Moreover, a command transmitting/receiving unit 22 is a part for transmitting a command (control signal) to control the source device 10 and for receiving a command (control signal) to the side of the sink device 20.

Specific standards include a high-definition multimedia interface (HDMI), a wired local area network (LAN), a wireless LAN, Bluetooth (registered trademark), etc. In the case of the HDMI, a consumer electronics control (CEC) line is used for the transmission/reception of the control command.

A display unit 25 is a screen for displaying the message screen for device control and images from the source device 10, and is specifically a liquid crystal panel or the like.

HDMI Terminal

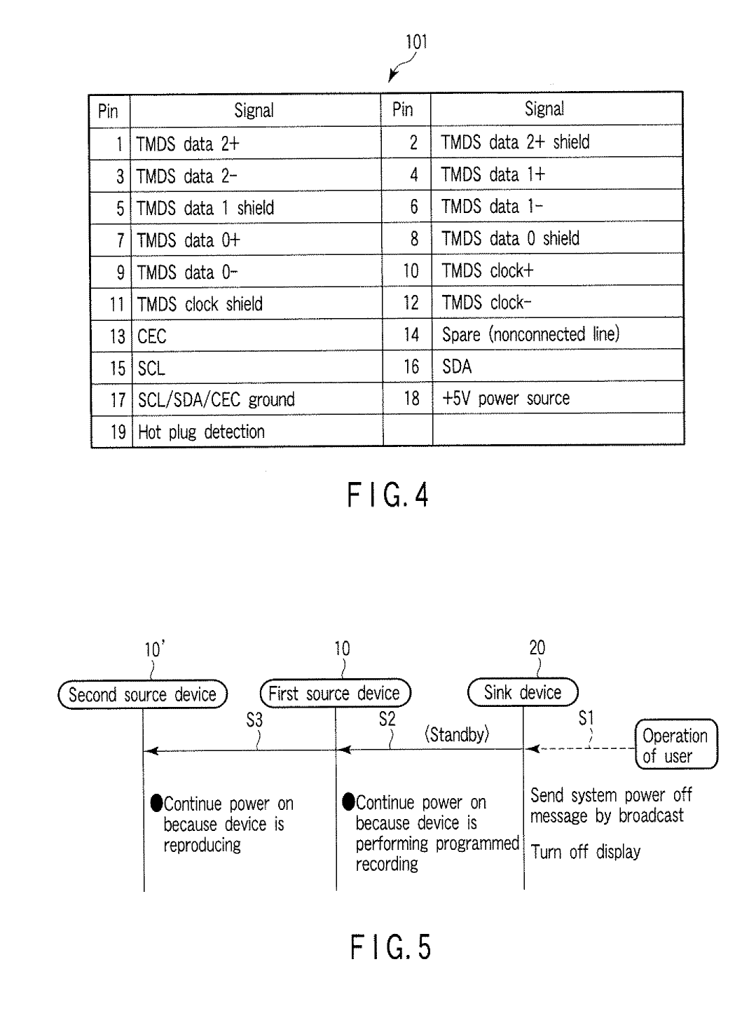

FIG. 4 is an explanatory diagram showing signal names of an HDMI terminal provided in the image processing apparatus according to one embodiment of the present invention.

When a communication is performed by the HDMI, the HDMI terminal has a connector pin assignment as shown in FIG. 4. In particular, if a command defined in conformity to an HDMI-CEC protocol is transmitted/received by a 13-pin CEC signal, the partner device can be controlled.

<One Example of Processing Prediction Method as One Embodiment of the Present Invention>

Next, one example of a processing prediction method in the image processing system described above is described in detail using a flowchart.

It is to be noted that steps of the flowcharts in FIG. 5 to FIG. 8 described below can be replaced with circuit blocks, and all the steps of the flowcharts can therefore be redefined as blocks.

(Troubles when Processing Prediction Method as One Embodiment of the Present Invention is not Implemented)

First, troubles when the processing prediction method as one embodiment of the present invention is not implemented are described. FIG. 5 is a flowchart showing one example of a device control operation to which the present invention is not applied in the case of turning off the system.

That is, as shown in the flowchart of FIG. 5, the sink device 20 broadcasts a “standby message” via the CEC line, for example, in accordance with a “system power off” operation of a user. Then, the sink device 20 turns off its power (step S1).

Here, the sink device 20 and the source device 10 perform processing corresponding to the “standby message”, but the source device 10 does not immediately turn off the power because it is recording and turns off the power after finishing the recording (step S2). Likewise, the second source device 10′ is reproducing and therefore does not turn off the power to wait for an operation of the user (step S3).

As a result, the first source device 10 and the second source device 10′ do not turn off the power and the sink device 20 alone turns off the power, which can be said to be processing that does not reflect the intension of the user.

Thus, in such an example in which the present invention is not carried out, the sink device can only inform the source devices of the power off operation even when receiving the “system power off” operation. The sink device does not have any means for answering the user how the informed source device is scheduled to operate later.

Therefore, there is caused such a disadvantage that the user can not ascertain how the source device which has actually received a command operates until the source device comes into the “system power off” operation.

In the above-described example to which the present invention is not applied, the power is not turned off in the devices which the user requests to turn off, such as a device during recording and a device during image reproduction. Therefore, the user has to again turn on the sink device 20 and communicate with the plurality of source devices 10, 10′ in order to ascertain or manipulate the state of the device which has not been turned off.

Thus, the problem of the above-described example to which the present invention is not carried out is that much time is required for the operation of the devices and that an operation desired by the user such as programmed recording of a recorder fails because the user has forgot the presence of the device which had not been turned off.

(One Example of Processing Prediction Method as First Embodiment of the Present Invention)

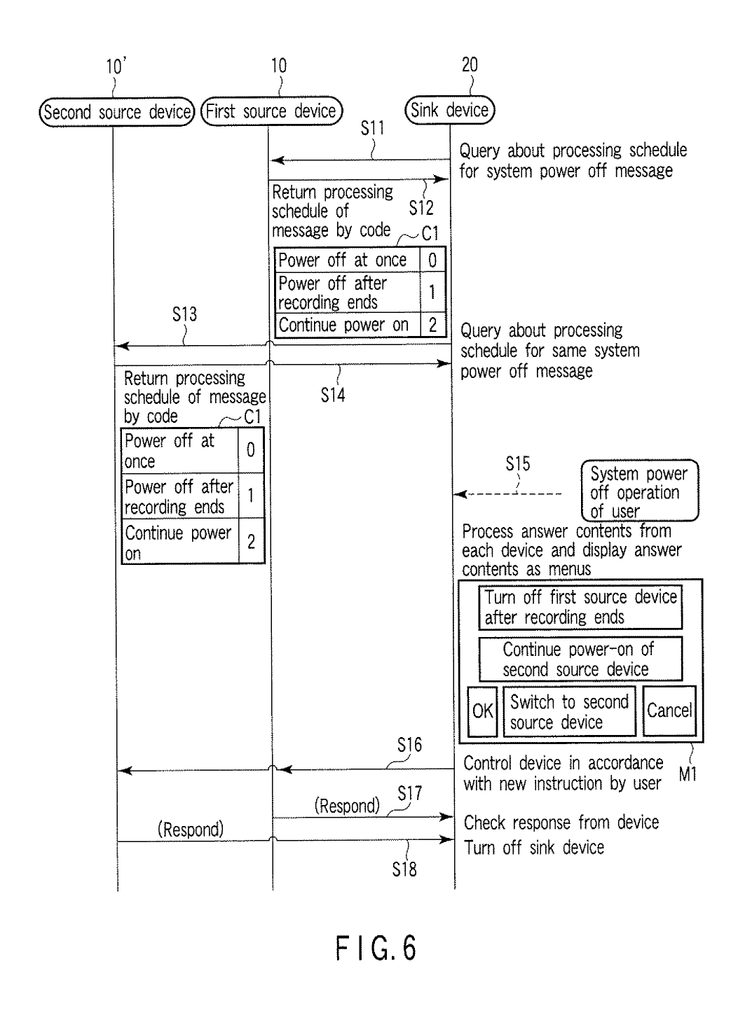

A processing prediction method as a first embodiment of the present invention is intended to solve such a problem, wherein information on a processing schedule of a source device corresponding to a predetermined command is previously collected via a communication line, and a message based on this information is displayed on the sink device. This makes it possible to avoid the misunderstanding of the user and erroneous operations. FIG. 6 is a flowchart showing one example of a processing prediction method for a sink device and source devices as the first embodiment of the present invention.

A control unit 24 and a processing prediction unit 24-1 of a sink device 20 as one embodiment of the present invention apply the processing prediction method as shown in the flowchart of FIG. 6. Here, two source devices including a first source device 10 and a second source device 10′ are connected to the sink device 20.

First, the control unit 24 and the processing prediction unit 24-1 of the sink device 20 query the first source device 10 “what kind of power management the source device 10 carries out if a ‘system power off message’ is received”, that is, a processing schedule in response to a system power off message (step S11).

In response to this, the control unit 14 and the processing prediction unit 14-1 of the first source device 10 answer the sink device 20 with a power management schedule corresponding to the temporary “system power off message” by use of one code in Code table 1 as shown in FIG. 6. However, a control unit 14 and a processing prediction unit 14-1 do not actually perform the “system power off” operation. Here, it is assumed that “power turned off after recording ends (0x01)” has been returned (step S12).

The control unit 24 and the processing prediction unit 24-1 of the sink device 20 make the same query to the second source device 10′ (step S13). In response to this, the control unit 14 and the processing prediction unit 14-1 of the second source device 10′ answer the sink device 20 with a power management schedule by use of one code in Code table 1, but do not actually perform the “system power off” operation. Here, it is assumed that “continue power on (0x02)” has been returned (step S14).

Then, when detecting the “system power off” operation of the user, the control unit 24 and the processing prediction unit 24-1 of the sink device 20 generate, on the basis of the code which is the answer of the first source device 10 and the second source device 10′, a menu M1 for the source device which is not turned off at once in response to the “system power off” operation, and then display the menu M1 to the user and prompt the user to make a selection (step S25). This menu M1 indicates that the first source device 10 is scheduled to be turned off after the recording ends and that the second source device 10′ is scheduled to continue leaving the power on. At the same time, this menu M1 additionally indicates, as currently operable options, whether to permit (perform) the “system power off” operation, whether to switch an image to the second source device 10′ which “continues power on” regardless of the “system power off” operation, and whether to cancel the “system power off” operation.

When the user operates the menu M1 via an interface such as a remote controller, the control unit 24 and the processing prediction unit 24-1 of the sink device 20 transmit an operation command corresponding to the user operation to the source devices 10, 10′ via a CEC control line 101-3, thereby controlling the source devices 10, 10′ (step S16). The control unit 24 and the processing prediction unit 24-1 ascertain a response from each of the source devices 10, 10′ to the operation command from the sink device 20 (steps S17, S18), and turn off the sink device 20.

Although steps S11 to S14 are carried out before the “system power off” operation of the user in this embodiment, it should be understood that these steps may also be carried out after the “system power off” operation of the user.

Thus, according to the processing prediction method as one embodiment of the present invention described above, it is possible to immediately present the conditions of the source devices 10, 10′ to the user without turning off the sink device 20 when the operation (system power off request) of the user can not be followed due to the source device 10. Since the user is able to know the current condition from the menu M1, there is no longer a need to take the trouble of again turning on the sink device 20 which has been once turned off and ascertaining the conditions of the source devices 10, 10′ in order to confirm the reason that the source devices 10, 10′ can not be turned off as has heretofore been the case. Moreover, the source device which can not be turned off is not overlooked, so that it is possible to eliminate operation errors such as the failure of programmed recording due to a continued power application of the source device, which can improve user convenience. Moreover, when there is a source device which can not be turned off, the user does not misunderstand that the system has failed.

### Second Embodiment of the Present Invention

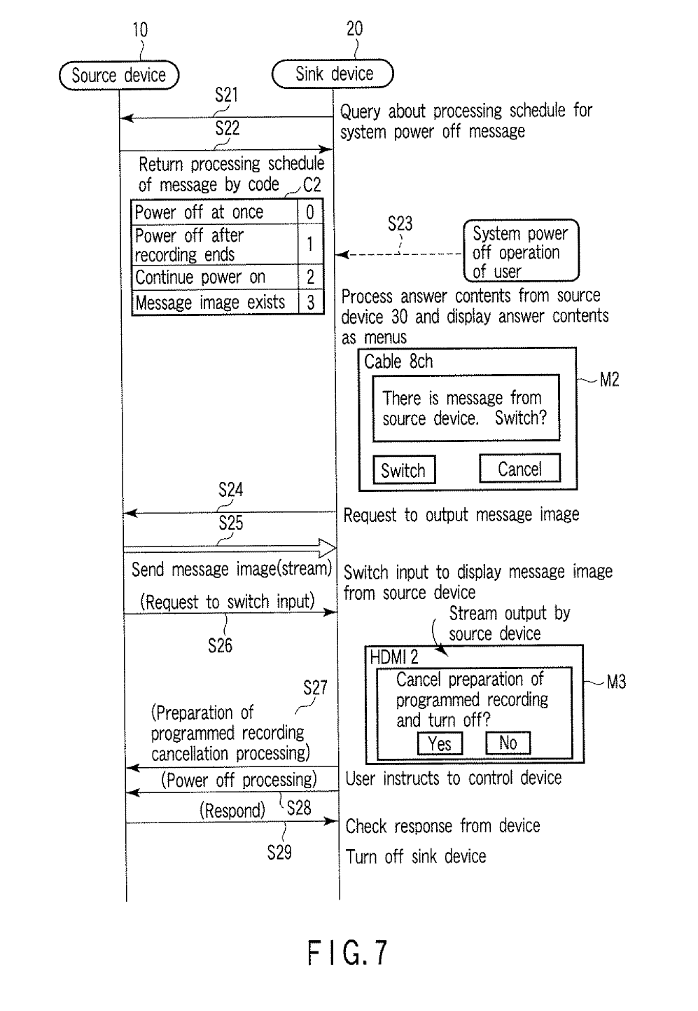

Next, a second embodiment of the present invention is described with FIG. 7. FIG. 7 is a flowchart showing a processing prediction method according to the second embodiment of the present invention.

Here, an explanation is made using the operation of one source device 10, but when a plurality of source devices 10 are connected, a similar operation is performed for each device.

First, a control unit 24 and a processing prediction unit 24-1 of a sink device 20 query a first source device 10 “what kind of power management the source device 10 carries out if a ‘system power off message’ is received”, that is, a processing schedule in response to a system power off message (step S21).

In response to this, a control unit 14 and a processing prediction unit 14-1 of the first source device 10 answer the sink device 20 with a power management schedule corresponding to the temporary “system power off message” by use of one code in Code table 2 as shown in FIG. 7, but do not actually perform the “system power off” operation. Here, it is assumed that “power turned off after recording ends (0x01)” has been returned (step S22). Here, “message image exists:3” is added as an option in Code table 2 shown in FIG. 7.

Then, when detecting the “system power off” operation of the user (step S23), the control unit 24 and the processing prediction unit 24-1 of the sink device 20 generate, on the basis of the code which is the answer of the first source device 10, a message image M2 for the source device which is not turned off at once in response to the “system power off” operation, and then display the message image M2 to the user and prompt the user to make a selection. In the message image M2, “switch” means switching to a message image M3 from the first source device 10. Moreover, “cancel” means canceling the “system power off” operation previously performed.

The user operates the message image M2 via an interface such as a remote controller. It is assumed here that “switch” has been selected. The control unit 24 and the processing prediction unit 24-1 of the sink device 20 request the source device 10 to output the message image M3 via a command transmission/reception line 101-3 (step S24). The source device 10 sends the message image M3 prompting the user operation as an image stream to the sink device 20 (step S25).

The control unit 24 and the processing prediction unit 24-1 of the sink device 20 switch an input signal to the source device 10, and display the message image M3 from the source device 10 (step S26).

The user operates the message image M3 via the interface such as the remote controller of the sink device 20, and performs an operation to cancel programmed recording processing (step S27). This can be presumed to be a case where the user has stopped a preparation of the programmed recording of, for example, a hard disk recorder halfway. That is, if the user selects “Yes” for the cancellation of the preparation of the programmed recording, a recording programming screen or programmed recording information for the relevant program in, for example, the hard disk recorder of the first source device 10 can be cancelled to turn off the first source device (step S28). Further, the control unit 24 and the processing prediction unit 24-1 of the sink device 20 ascertain a response from the source device 10, and turn off the sink device 20 (step S29).

Although a message image M1 of the processing schedule in FIG. 6 is not displayed in this embodiment, it may be displayed.

Moreover, although steps S21 to S22 are carried out before the “system power off” operation of the user in the embodiment, these steps may also be carried out after the “system power off” operation of the user.

Furthermore, although the switch of the input signal of the sink device 20 in step S24 is carried out by the sink device 20 itself in the embodiment described above, the input signal may be switched by an input switch request command from the source device 10.

As described above, in the embodiment of the flowchart in FIG. 7, it is possible to present more detailed information to the user by means of the message images M2, M3 from the source device 10 and achieve a more convenient operation, in addition to the effects of the embodiment of the flowchart in FIG. 6.

### Third Embodiment of the Present Invention

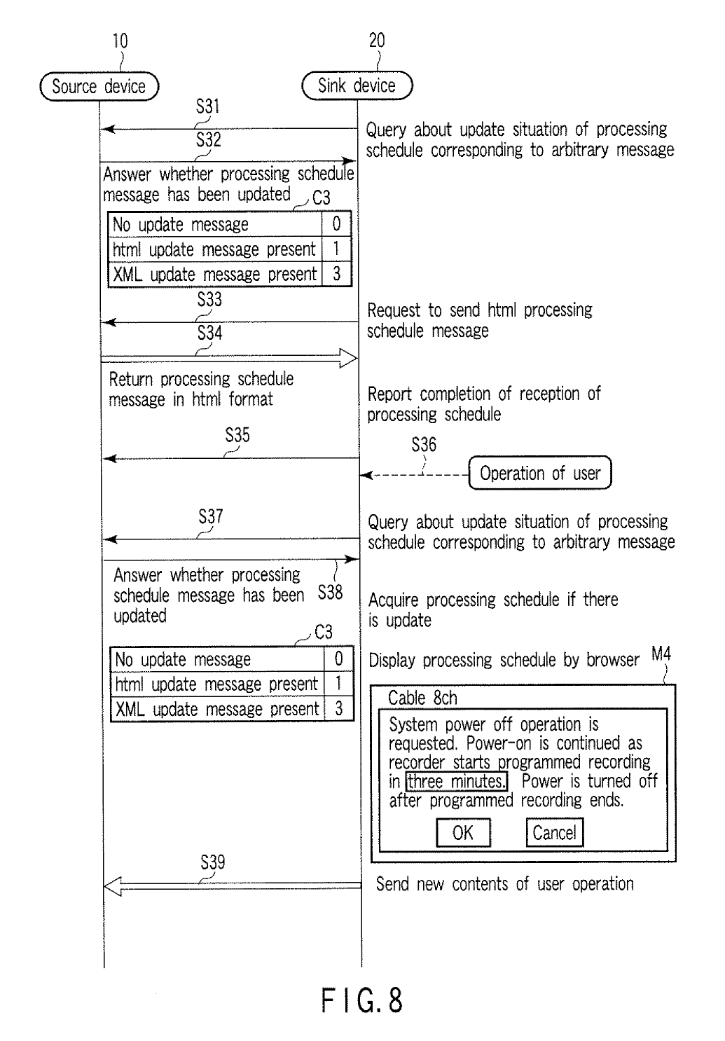

Next, one example of a processing prediction method according to a third embodiment of the present invention is described. FIG. 8 is a flowchart showing an operation in the third embodiment. In this embodiment, a message image of a processing schedule is transferred using html or XML. A processing schedule is acquired in advance, and a query is then made whether this processing schedule has been updated. If the processing schedule has been updated, a message image of the latest processing schedule is acquired.

First, a control unit 24 and a processing prediction unit 24-1 of a sink device 20 query a first source device 10 on the update situation of a processing schedule for an arbitrary message (step S31). For example, the control unit 24 and the processing prediction unit 24-1 query the first source device 10 whether a processing schedule for the system power off message as described above has been updated.

In response to this, a control unit 14 and a processing prediction unit 14-1 of the first source device 10 answer the sink device 20 with an update situation of the processing schedule for the temporary message by use of one code in Code table 3 as shown in FIG. 8 (step 332). Here, it is assumed that “html message image updated (0x01)” has been returned.

Then, the control unit 24 and the processing prediction unit 24-1 of the sink device 20 request the source device 10 to send an updated processing schedule (step S33).

In response to this, the control unit 14 and the processing prediction unit 14-1 of the source device 10 send an updated processing schedule corresponding to the temporary message as a response message in an html format via a CEC signal line 101-3 (step S34).

The control unit 24 and the processing prediction unit 24-1 of the sink device 20 ascertain that the processing schedule has been correctly received, and inform the source device 10 of the completion of the reception of the processing schedule (step S35).

Then, when an operation of the user is input (step S36), the control unit 24 and the processing prediction unit 24-1 of the sink device 20 again query the first source device 10 on the update situation of the processing schedule for the temporary message (step S37).

In response to this, the control unit 14 and the processing prediction unit 14-1 of the source device 10 answer the sink device 20 on the update situation of the processing schedule for the temporary message (step S38).

Here, if there is a further update in the processing schedule of the source device 10, the sink device 20 repeats step S33 to step S35 to acquire a processing schedule. Here, as there is “no update (0x00)”, no processing schedule is newly acquired.

The control unit 24 and the processing prediction unit 24-1 of the sink device 20 form an image to display a message image M4 indicating an acquired processing schedule, and prompt the user to make a selection in this screen. Here, acquired html data is displayed by the sink device 20 using a browser function.

The user operates the source device 10 via the message image M4 which is a browser screen. That is, the control unit 24 and the processing prediction unit 24-1 of the sink device 20 transmit operation contents as an operation signal to the source device 10 (step S39) Here, an example is shown in which an operation message is sent in an XML format via the CEC signal line.

Although the message of the updated processing schedule is data in the html format in the explanation made here, the data may be in the XML format or may be in other data formats. Moreover, although the operation signal transmitted by the user is the data in the XML format in this explanation, the operation signal may be data in the html format or any other device control message.

Furthermore, although it has been explained that a communication channel used for sending the response message and the operation message is a CEC control line shown by a 13-pin CEC in FIG. 2, an address/data control line shown by 15-pin SCL or 16-pin SDA in FIG. 2, that is, a DDC (Display Data Channel) signal line of an HDMI standard may be used.

Still further, the update situation of the processing schedule for the temporary message transmitted from the control unit 14 and the processing prediction unit 14-1 of the source device 10 may be reported every time the processing schedule is updated even if no query is made from the sink device 20.

As described above, in the third embodiment, html is used for the answer message, and a browser is used to display the message, such that it is possible to provide more information to the user with extremely light processing in the system. Moreover, html and XML are used for the device control data, thereby allowing a more detailed and flexible device operation and good expandability of a device control function.

Further yet, as the response message is previously acquired before the user operation, the response message can be immediately displayed in response to the user operation, resulting in good operability.

<Example of Command Used in the Embodiments Described Above>

Next, the commands used in the above-described image processing system comprising the sink device 20 and the source device 10 are described below in detail.

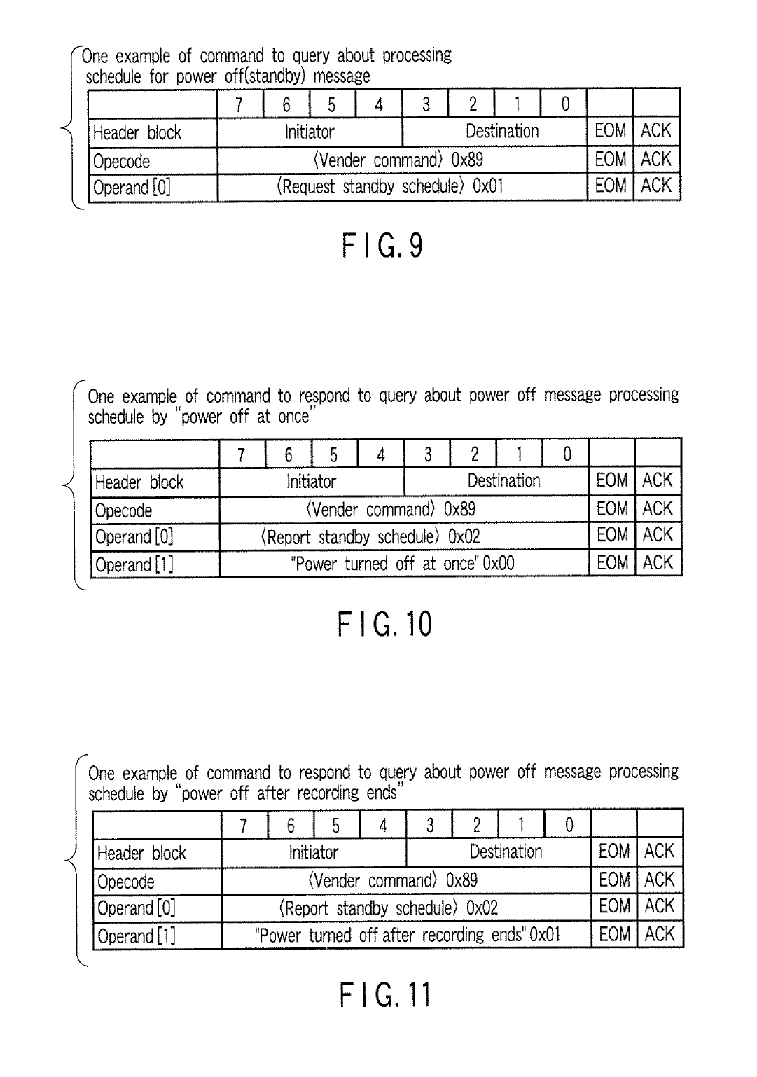

FIG. 9 shows one embodiment of a command to query about a processing schedule for a power off message, and this command is transmitted from the sink device 20 to the source device 10.

In FIG. 9, a logical address of the sink device 20 is put in an initiator of a header block, and an operand [0] indicates a query on what kind of processing (here, power management) the source device 10 performs if a “power off (standby) message” is transmitted to the source device 10 of a logical address indicated by a destination. Details of the logical address, initiator, destination, EOM and ACK are described in an HDMI specification.

FIG. 10 shows one embodiment of a command to respond to a query command for a power off (standby) message processing schedule by “power turned off at once”, and this command is transmitted from the source device 10 to the sink device 20.

In FIG. 10, a logical address of the source device 10 is put in an initiator of a header block, and a code (0x00) of an operand [1] indicates that the source device 10 performs the “power turned off at once” if the sink device 20 of a logical address indicated by a destination transmits a “power off (standby) message”.

FIG. 11 shows one embodiment of a command to respond to a query command for the power off (standby) message processing schedule by “power turned off after recording ends”, and this command is transmitted from the source device 10 to the sink device 20.

In FIG. 11, the logical address of the source device 10 is put in an initiator of a header block, and a code (0x01) of an operand [1] indicates that the source device 10 performs the “power turned off after recording ends” if the sink device 20 of a logical address indicated by a destination transmits a “power off (standby) message”.

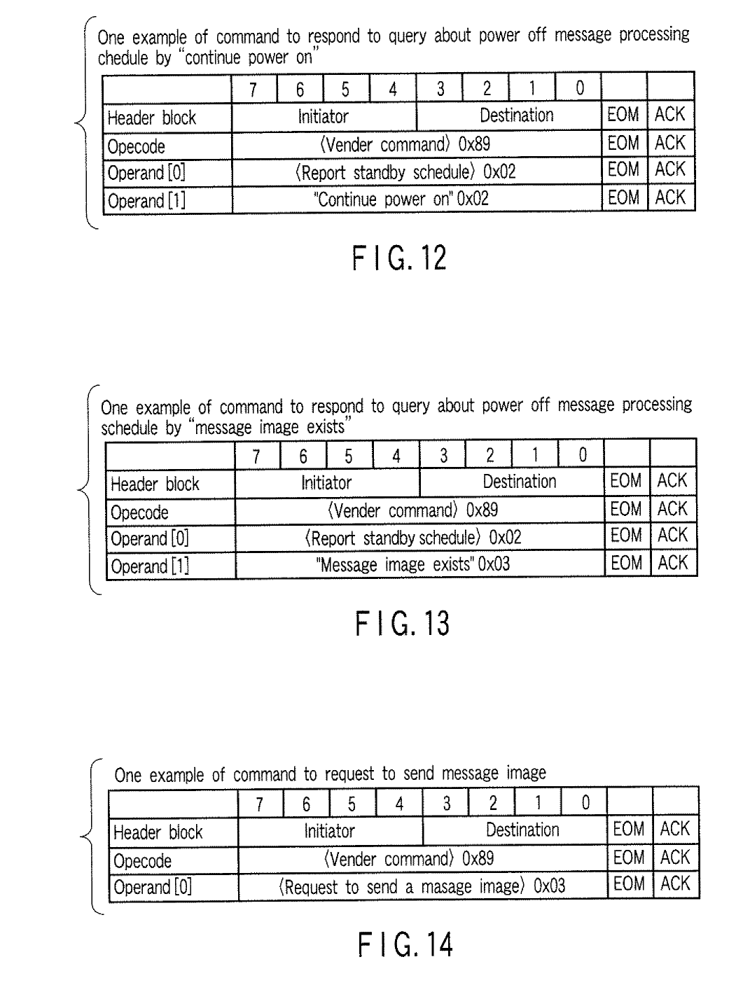

FIG. 12 shows one embodiment of a command to respond to a query command for the power off (standby) message processing schedule by “continue power on”, and this command is transmitted from the source device to a display device.

In FIG. 12, the logical address of the source device 10 is put in an initiator of a header block, and a code (0x02) of an operand [1] indicates that the source device 10 performs the “continue power on” if the sink device 20 of a logical address indicated by a destination transmits a “power off (standby) message”

FIG. 13 shows one embodiment of a command to respond to a query command for the power off (standby) message processing schedule to indicate that a “message image exists”, and this command is transmitted from the source device 10 to the sink device 20.

In FIG. 13, the logical address of the source device 10 is put in an initiator of a header block, and a code (0x03) of an operand [1] indicates that a “message image exists” in the source device 10 if the sink device 20 of a logical address indicated by a destination transmits a “power off (standby) message”.

FIG. 14 shows one embodiment of a command to request to send a message, and this command is transmitted from the sink device 20 to the source device 10.

In FIG. 14, the logical address of the sink device 20 is put in an initiator of a header block, and a code (0x03) of an operand [0] indicates a “request to send a message image” which is made to the source device 10 of a logical address indicated by a destination.

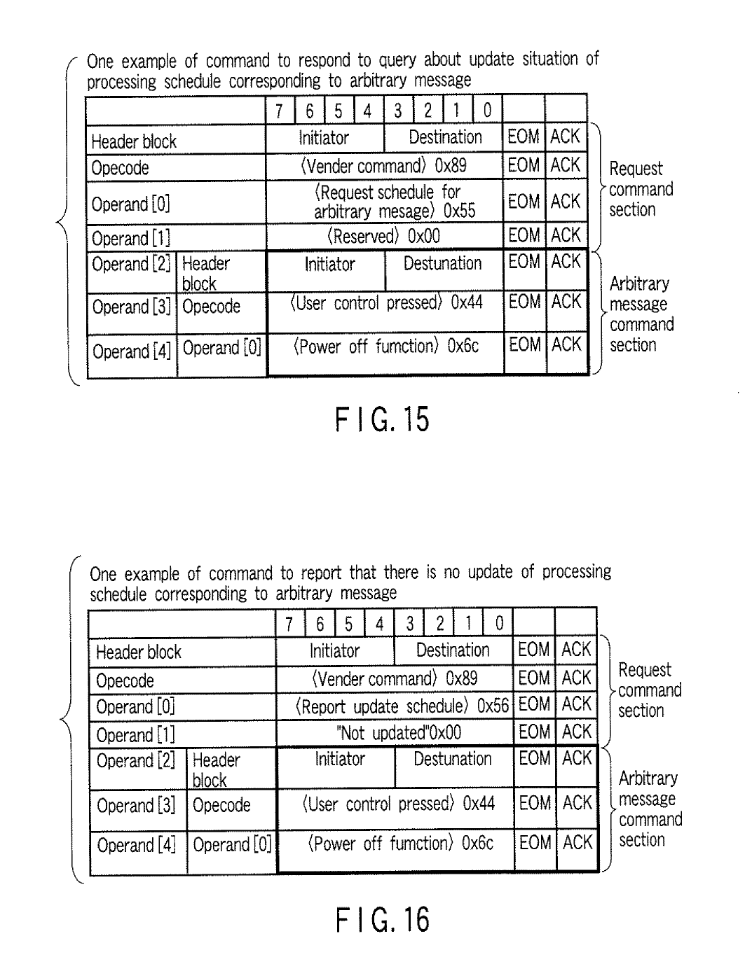

FIG. 15 shows one embodiment of a command to query about the update situation of a processing schedule corresponding to an arbitrary message, and this command is transmitted from the sink device 20 to the source device 10.

This command comprises a request command section which is composed of a header block, an opecode, an operand [0] and an operand [1], and a command section which is composed of an operand [2], an operand [3] and an operand [4] and which indicates the following arbitrary message. The logical address of the sink device 20 is put in an initiator of the header block, and a code (0x55) of the operand [0] indicates a “request to report the update situation of the processing schedule for an arbitrary message” which is made to the source device 10 of a logical address indicated by a destination. The operand [1] is reserve data provided to be consistent with other command structures.

A message prescribed by the HDMI specification is supposed to be used for the next arbitrary message. The logical address of the sink device 20 is put in an initiator of a header block located in the operand [2], and an arbitrary command for transmission to a logical address indicated by a destination is described from the operand [3]. Here, a code (0x44) of the operand [3] and a code (0x6c) of the operand [4] indicate that the operation of the user is an operation to turn off the device.

FIG. 16 shows one embodiment of a command to indicate that there is no update processing of the processing schedule corresponding to an arbitrary message, and this command is transmitted from the source device 10 to the sink device 20.

This command comprises a request command section which is composed of a header block, an opecode, an operand [0] and an operand [1], and a command section which is composed of an operand [2], an operand [3] and an operand [4] and which indicates the following arbitrary message. The logical address of the source device 10 is put in an initiator of the header block, and a code (0x56) of the operand [0] indicates a “report on the update situation of the processing schedule” to be made by the sink device 20 of a logical address indicated by a destination. The operand [1] indicates with a code (0x00) that there is no update of the processing schedule.

A message prescribed by the HDMI specification is supposed to be used for the succeeding arbitrary message. The logical address of the sink device 20 is put in an initiator of a header block located in the operand [2], and an arbitrary command to be reported to a logical address indicated by a destination is described from the operand [3]. Here, a code (0x44) of the operand [3] and a code (0x6c) of the operand [4] indicate that the operation of the user is an operation to turn off the device.

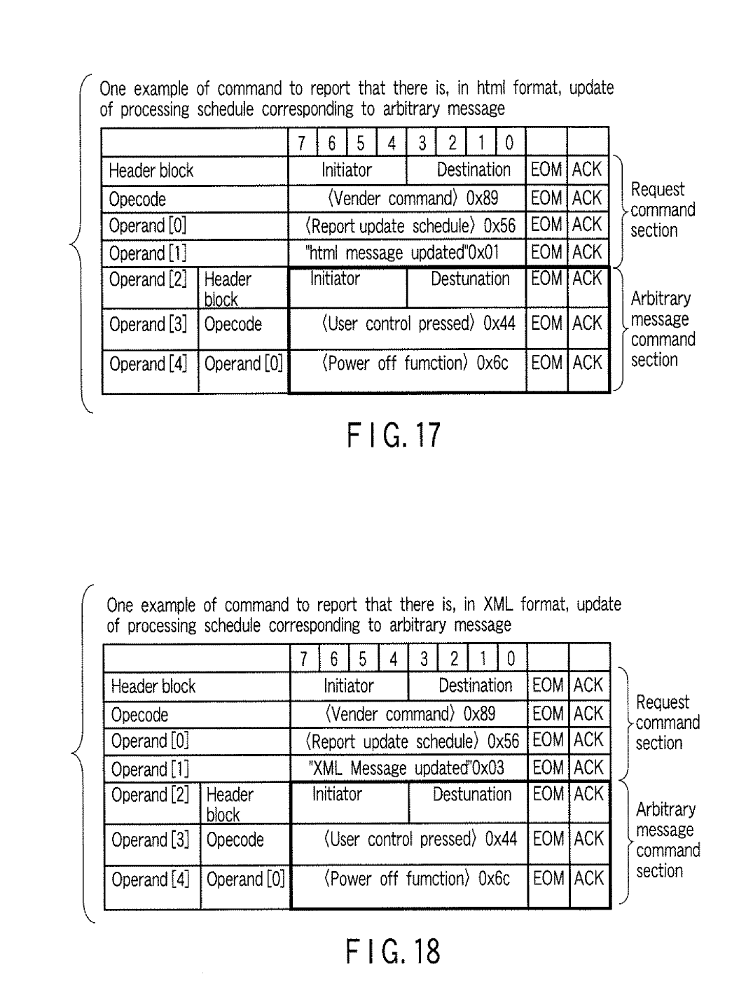

FIG. 17 shows one embodiment of a command to indicate that there is, in an html format, update processing of the processing schedule corresponding to an arbitrary message, and this command is transmitted from the source device 10 to the sink device 20.

In FIG. 17, the command comprises a request command section which is composed of a header block, an opecode, an operand [0] and an operand [1], and a command section which is composed of an operand [2], an operand [3] and an operand [4] and which indicates the following arbitrary message. The logical address of the source device 10 is put in an initiator of the header block, and a code (0x56) of the operand [0] indicates a “report on the update situation of the processing schedule” which has been made by the sink device 20 of a logical address indicated by a destination. The operand [1] indicates with a code (0x00) that there is an update of the processing schedule in the html format.

A message prescribed by the HDMI specification is supposed to be used for the succeeding arbitrary message. The logical address of the sink device 20 is put in an initiator of a header block located in the operand [2], and an arbitrary command to be reported to a logical address indicated by a destination is described from the operand [3]. Here, a code (0x44) of the operand [3] and a code (0x6c) of the operand [4] indicate that the operation of the user is an operation to turn off the device.

FIG. 18 shows one embodiment of a command to indicate that there is, in an XML format, update processing of the processing schedule corresponding to an arbitrary message, and this command is transmitted from the source device 10 to the sink device 20.

This command comprises a request command section which is composed of a header block, an opecode, an operand [0] and an operand [1], and a command section which is composed of an operand [2], an operand [3] and an operand [4] and which indicates the following arbitrary message. The logical address of the source device 10 is put in an initiator of the header block, and a code (0x56) of the operand [0] indicates a “report on the update situation of the processing schedule” to be made by the sink device 20 of a logical address indicated by a destination. The operand [1] indicates with a code (0x03) that there is an update of the processing schedule in the XML format.

A message prescribed by the HDMI specification is supposed to be used for the succeeding arbitrary message. The logical address of the sink device 20 is put in an initiator of a header block located in the operand [2], and an arbitrary command to be reported to a logical address indicated by a destination is described from the operand [3]. Here, a code (0x44) of the operand [3] and a code (0x6c) of the operand [4] indicate that the operation of the user is an operation to turn off the device.

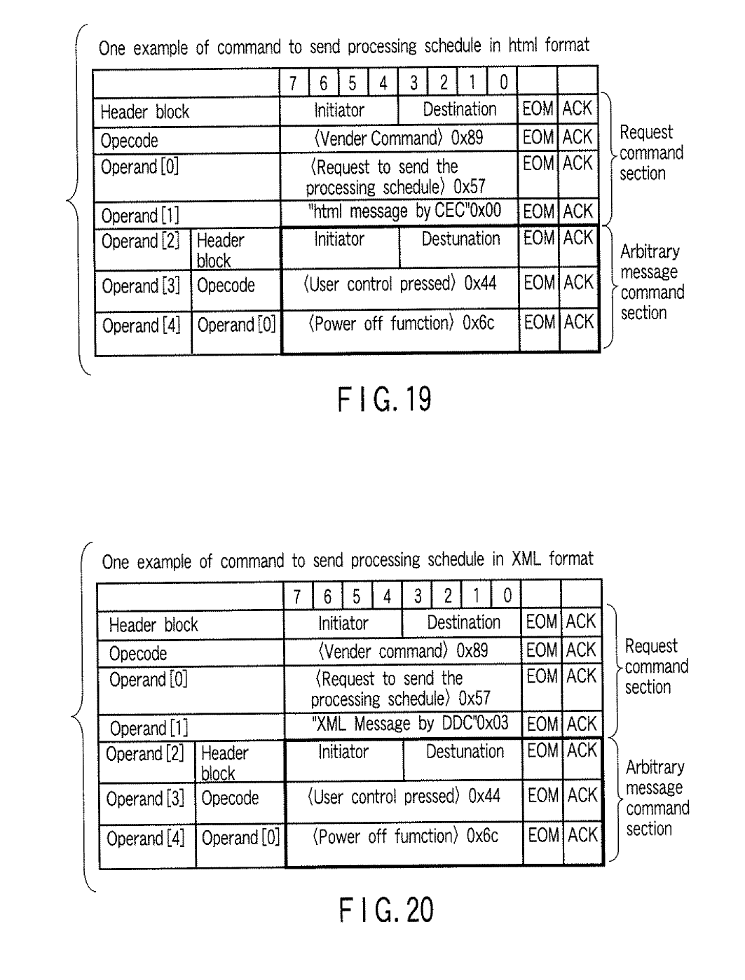

FIG. 19 shows one embodiment of a command to request to send the processing schedule in the html format. This command is transmitted from the sink device 20 to the source device 10.

This command comprises a request command section which is composed of a header block, an opecode, an operand [0] and an operand [1], and a command section which is composed of an operand [2], an operand [3] and an operand [4] and which indicates the following arbitrary message. The logical address of the sink device 20 is put in an initiator of the header block, and a code (0x57) of the operand [0] indicates a “request to send the processing schedule” which is made to the source device 10 of a logical address indicated by a destination. The operand [1] indicates with a code (0x01) a request to send an updated processing schedule in the html format using the CEC control line.

A message prescribed by the HDMI specification is supposed to be used for the succeeding arbitrary message. The logical address of the sink device 20 is put in an initiator of a header block located in the operand [2], and an arbitrary command to be reported to a logical address indicated by a destination is described from the operand [3]. Here, a code (0x44) of the operand [3] and a code (0x6c) of the operand [4] indicate that the operation of the user is an operation to turn off the device.

FIG. 20 shows one embodiment of a command to request to send the processing schedule in the XML format, and this command is transmitted from the sink device 20 to the source device 10.

In FIG. 20, the command comprises a request command section which is composed of a header block, an opecode, an operand [0] and an operand [1], and a command section which is composed of an operand [2], an operand [3] and an operand [4] and which indicates the following arbitrary message. The logical address of the sink device 20 is put in an initiator of the header block, and a code (0x57) of the operand [0] indicates a “request to send the processing schedule” which is made to the source device 10 of a logical address indicated by a destination. The operand [1] indicates with a code (0x03) a request to send an updated processing schedule in the XML format using the address/data transmission/reception line.

A message prescribed by the HDMI specification is supposed to be used for the succeeding arbitrary message. The logical address of the sink device 20 is put in an initiator of a header block located in the operand [2], and an arbitrary command to be reported to a logical address indicated by a destination is described from the operand [3]. Here, a code (0x44) of the operand [3] and a code (0x6c) of the operand [4] indicate that the operation of the user is an operation to turn off the device.

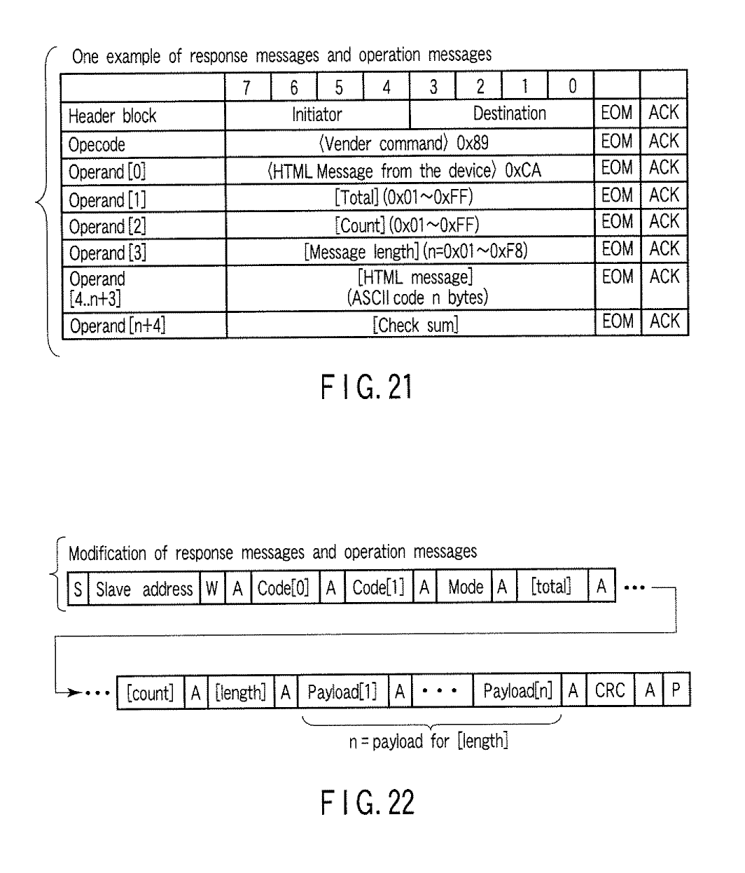

FIG. 21 shows one embodiment of response messages and operation messages, and this command is transmitted from the source device 10 to the sink device 20.

Here, a message is supposed to be transmitted by the CEC control line 101-3. Since the size of the whole message is indefinite, the whole message is divided into a plurality of messages, and each message is sent with a number assigned thereto. Here, the size of one message is restricted to 256 bytes. The logical address of the source device 10 is put in an initiator of the header block, and a code (0xCA) of the operand [0] indicates an “html message” to the sink device 20 of a logical address indicated by a destination. An operand [1] indicates that one html message is sent in a form divided by the number indicated by [total]. An operand [2] indicates that the relevant message is the [count]-th message among the divided messages. The operand [3] indicates with [message length] the number of a payload in the relevant message. An operand [4 . . . n+3] is a payload (html message data) indicated by an ASCII code. An operand [n+4] indicates the checksum of the whole relevant message.

FIG. 22 shows a modification of the response messages and the operation messages.

Here, a message is supposed to be transmitted by the address/data transmission/reception line. Since the size of the whole message is indefinite, the whole message is divided into a plurality of messages, and each message is sent with a number assigned thereto.

Here, the payload of the size of one message is restricted to 256 bytes.

S is a start condition indicating the start of transmission. P is a stop condition indicating the end of the transmission. Slave Address has seven bits, and specifies an address of data. W has one bit, and indicates that the transmission of data is directed from the source device 10 to the sink device 20. Code [0] and Code [1] each have eight bits and indicate an arbitrary message command. Mode indicates the kind of a response message. [total] indicates the number in which the whole response message is divided. [count] indicates the number of a message among the divided message. [length] indicates the number of a payload. The payload is response data, and has 256 bytes per message. CRC is a code for verifying the validity of sent data.

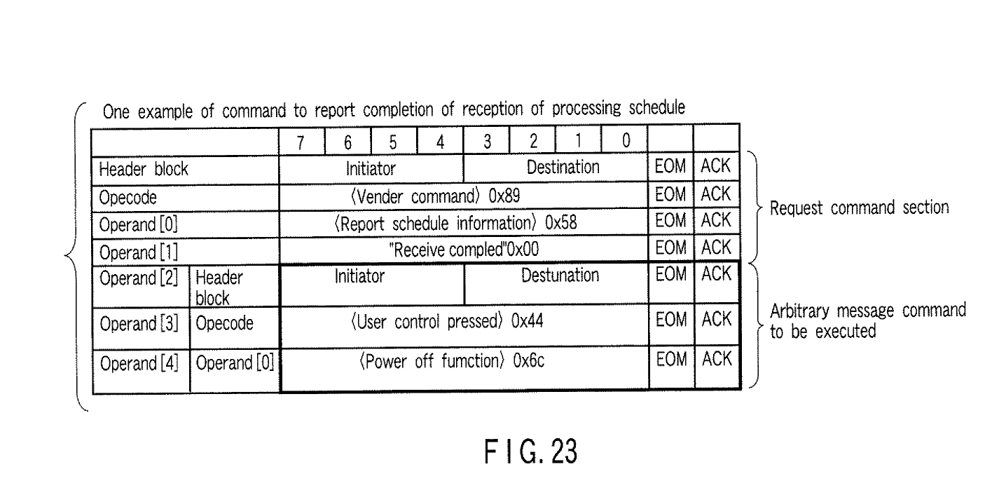

Finally, FIG. 23 shows one embodiment of a command to report the completion of the reception of the processing schedule, and this command is transmitted from the sink device 20 to the source device 10.

In FIG. 23, this command comprises a request command section which is composed of a header block, an opecode, an operand [0] and an operand [1], and a command section which is composed of an operand [2], an operand [3] and an operand [4] and which indicates an arbitrary message to be executed. The logical address of the sink device 20 is put in an initiator of a header block, and a code (0x58) of the operand [0] indicates “reception situation of processing schedule information” to the source device 10 of a logical address indicated by a destination. The operand [1] is a command to report that the entire processing schedule has been received.

A message prescribed by the HDMI specification is supposed to be used for the succeeding arbitrary message. The logical address of the sink device 20 is put in an initiator of a header block located in the operand [2], and an arbitrary command to be reported to a logical address indicated by a destination is described from the operand [3]. Here, a code (0x44) of the operand [3] and a code (0x6c) of the operand [4] indicate that the operation of the user is an operation to turn off the device.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An image processing apparatus comprising:
a communication unit which receives video/audio signals from another image processing apparatus via a communication channel at a first rate and which communicates a control signal to/from with the another image processing apparatus via the communication channel at a second rate lower than the first rate;
a processing prediction unit, the processing prediction unit transmitting, to the another image processing apparatus via the communication unit, a request signal to request the transmission of a processing schedule for a predetermined command, and receiving a message signal indicating the processing schedule corresponding to the predetermined command from the another image processing apparatus via the communication unit, the processing prediction unit generating an image showing the processing schedule of the another image processing apparatus when a request to execute the predetermined command is input; and
a display unit which displays, on a screen, an image corresponding to the video/audio signals received via the communication unit and an image generated by the processing prediction unit and showing the processing schedule.

2. The image processing apparatus according to claim 1, wherein the predetermined command handled by the processing prediction unit is a control signal to turn off the another image processing apparatus.

3. The image processing apparatus according to claim 1, wherein the image generated by the processing prediction unit and showing the processing schedule includes an image showing options of possible operations together with the processing schedule of the another image processing apparatus.

4. The image processing apparatus according to claim 1, wherein when it is reported by the another image processing apparatus that a message screen exists, the processing prediction unit displays the message screen together with the options of the possible operations on the display unit.

5. The image processing apparatus according to claim 1, wherein the processing prediction unit previously acquires a message image from the another image processing apparatus and then checks whether this message image has been updated, and when the message image has been updated, the processing prediction unit acquires an updated message image and displays the updated message image.

6. The image processing apparatus according to claim 1, wherein the processing prediction unit receives the message signal indicating the processing schedule corresponding to the predetermined command from the another image processing apparatus in an html format.

7. The image processing apparatus according to claim 1, wherein the processing prediction unit receives the message signal indicating the processing schedule corresponding to the predetermined command from the another image processing apparatus in an XML format.

8. The image processing apparatus according to claim 1, wherein the processing prediction unit receives the message signal indicating the processing schedule corresponding to the predetermined command via a CEC signal line of an HDMI standard of the communication unit.

9. The image processing apparatus according to claim 1, wherein the processing prediction unit receives a message signal indicating a processing schedule of the another image processing apparatus via a DDC signal line of an HDMI standard of the communication unit.

10. The image processing apparatus according to claim 1, wherein on receipt of a message signal indicating the processing schedule from the another image processing apparatus, the processing prediction unit uses a browser function to generate and output an image signal showing the processing schedule indicated by the message signal.

11. The image processing apparatus according to claim 1, further comprising a control unit which executes processing corresponding to an operation signal for the processing schedule displayed by the display unit, when receiving this operation signal.

12. An image processing system comprising a first image processing apparatus which receives video/audio signals via a communication channel and reproduces the video/audio signals, and a second image processing apparatus which is connected to the first image processing apparatus via the communication channel and which transmits the video/audio signals to the first image processing apparatus via the communication channel,
the first image processing apparatus including:
a first communication unit which receives the video/audio signals from the second image processing apparatus via the communication channel at a first rate and which communicates a control signal to/from the second image processing apparatus via the communication channel at a second rate lower than the first rate;
a first processing prediction unit, the first processing prediction unit transmitting, to the second image processing apparatus via the first communication unit, a request signal to request the transmission of a processing schedule for a predetermined command, and receiving a message signal indicating the processing schedule corresponding to the predetermined command from the second image processing apparatus via the first communication unit, the processing prediction unit generating an image showing the processing schedule of the second image processing apparatus when a request to execute the predetermined command is input; and
a display unit which displays, on a screen, an image corresponding to the video/audio signals received via the first communication unit and an image generated by the processing prediction unit and showing the processing schedule,
the second image processing apparatus including:
a generating unit which generates the video/audio signals;
a second communication unit which transmits the video/audio signals from the generating unit to the first image processing apparatus via the communication channel at the first rate and which communicates a control signal to/from the first image processing apparatus via the communication channel at the second rate; and
a second processing prediction unit which receives, from the first image processing apparatus via the second communication unit, the request signal to request the transmission of the processing schedule for the predetermined command and which transmits the message signal indicating the processing schedule corresponding to the predetermined command to the first image processing apparatus.
